(19) United States
(12) Patent Application Publication
(10) Pub. No.: US 2012/0169860 A1
(43) Pub. Date: Jul. 5, 2012

(54) METHOD FOR DETECTION OF A BODY PART GESTURE TO INITIATE A WEB APPLICATION

(76) Inventors: Guan Lian, Sunnyvale, CA (US); Liu Liu, Sunnyvale, CA (US)

(21) Appl. No.: 13/173,536

(22) Filed: Jun. 30, 2011

Related U.S. Application Data
(60) Provisional application No. 61/360,095, filed on Jun. 30, 2010.

(51) Int. Cl. H04N 7/18

(52) U.S. Cl. 348/77; 348/E07.085

(57) ABSTRACT

The present invention relates a system and method in a wire communication network for using a movement pattern of a selected body part of a user by a computer system to invoke a network application.

This application claims priority of U.S. provisional application No. 61/360,095 filed on Jun. 30, 2010 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates a system and method in a wire communication network for using a movement pattern of a selected body part of a user by a computer system to invoke a network application.

2. Description of Related Art

The interaction between humans and computers is still mostly based on mechanical/electronic input devices such as keyboards, mouses, joysticks, or game pads. More recently, non-mechanical means of delivering an interaction have started to become popular, such as voice commands. The interaction of body movements as an input device has been implemented to a certain degree and electronic devices that include sensing of movement have played a large role in more recent gaming devices. The recognition of a human gesture without the need to interface with a mechanical or electronic device to create an input has been the next logical means for human computer interface.

Gesture recognition relies on recognition using a camera or stereo pair of cameras as an input. Input has been made easier with some methods where gloves or markers on the hand or fingers are utilized or where a controlled background is used to aid in locating a hand even in real time. Accelerometers have been utilized to aid in detecting movement strength and direction with these methods. Only if a body part is recognizable in essentially real time is it valuable as an input device in programs, such as games, which require rapid fire inputting. Very few methods, if any, can actually utilize a web camera and operate in real time. The best current methods require segmentation from the background before recognition and use of color cues to accomplish the segmentation frequently fail due to light variations and the wide variety of actual skin tones, hue, and color saturation. They frequently, if not always, also require that the software learn the individual user's body part directly by scanning the body part in some form of learning phase which limits the use to those that have taken the time to go through this procedure, and thus are not useful in public computers or where new input users are temporarily needing to use the computer. Further, they usually only recognize a static gesture such as a closed fist and are not capable of recognizing movement type gestures. In addition, they utilize such high computer memory that they can interfere with the online connection or the functioning of other software on the computer during use. The ability to recognize a body part and corresponding desired movement recognition while not monopolizing computer resources would be useful to advance gesture recognition as an input method.

### BRIEF SUMMARY OF THE INVENTION

The present invention relates to a method of detecting a particular user movement pattern of a body part by a web type camera to invoke a wire communication network application. By collecting a plurality of references and comparing pixilated images, the method can identify both the body part and a selected movement without requiring that the entire image be analyzed.

In one particular embodiment, the invention relates to a method of communicating a selected user movement pattern of a select body part to invoke a wire communication network application using a camera attached to a wire communication network communication terminal comprising:
a) capturing a pixilated digital image of the user by the camera;
b) delivering the image to the terminal;
c) detecting if the selected body part is in the image and recording its position;
d) repeating steps a) through c) and collecting multiple body part positions and their pattern;
e) comparing the multiple positions pattern to a reference pattern until a selected movement pattern is detected;
f) sending information from the terminal to the wire communication network that the movement pattern is detected; and
g) engaging the wire communication network application based on the body part movement pattern.

In yet another embodiment, it relates to detecting a body part gesture by the method comprising:
a) creating a HOG image of a given gray-scale image;
b) applying a binary predictor to selected regions of the image and determining which region could be of the selected body part;
c) applying a boosting classifier to the regions which could be the selected body part; and
d) applying a sequential cascade of the boost classified regions against a reference body part until the classified regions are accepted or rejected as being from a selected body part.

In another embodiment, it relates to offline training a cascade classifier of a body part gesture by the method comprising:
a) collecting a select number of samples of desired body part identified as positive;
b) collecting samples identified as a negative that cannot be correctly rejected by the classifier;
c) selecting best performance binary predictors in the samples, and composing boosting classifier with the samples until the selected detecting rate/false alarm rate is reached;
d) composing a new cascade classifier with current boosting classifier, repeat steps b) to c) until a global detecting rate/false alarm rate is reached.

### BRIEF DESCRIPTION OF THE DRAWINGS

FIG. 1 is a flow chart of the method of the present invention.

FIG. 2 is a relationship chart of the method of triggering a Web application.

FIG. 3 is a flow chart for determining if a digital image contains a selected body part.

FIG. 4 is a vector representation of a HOG image

FIG. 5 is a binary predictor using HOG images

FIG. 6 represents both boost classifier and cascade classifier.

FIG. 7 shows how the HOG image can output possible locations of the selected body part.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “selected user movement” refers to a gesture made by an individual and viewed by a camera on a communication terminal. These are movements as opposed to a static non-moving body part. Therefore, while recognition of a face or hand would be a static recognition, waving a hand, moving a hand, arm to the left or right, or shaking the head will be a movement associated with a body part. The selected user movement is any movement that is decided to represent a particular activity engaged in by a network application. For example, a wave of the hand could engage the beginning of a game.

As used herein the term “selected body part” refers to a body part on a user, such as a human, that is capable of making a movement or gesture. For example, a hand, arm, foot, leg, head, fingers, eyes, mouth, and the like are all capable of making a user movement such as waving, opening the hand, shaking a fist, flapping the arms, shaking the head yes or no, and the like.

As used herein the term “wire communication network application” refers to the internet, an intranet, or any interconnected network for connecting computers or terminals.

As used herein the term “camera” refers to a web type camera that is connected to the wire communication network via a local terminal such as a computer. It is intended to mean a real time camera that takes a live video picture of a person to which a body part determination is going to be made. The resolution and number of pixels will be determined by the camera manufacture and is not a factor for the most part in the practice of the invention as long as the picture/movie it delivers is in a pixilated format.

As used herein the term “wire communication network communication terminal” refers to any kind of computer or digital terminal which is connected to a wire communication network and is capable of running a camera as disclosed above. The computer can take computer executable instructions stored in the memory which are executed by the computer processor. The memory may queue data in the memory and utilize the data as needed from memory storage. In one embodiment the data is in the form of first in/first out data queue.

As used herein the term “pixilated digital image” refers to a picture or video in digital format taken by the camera of the present invention. The pixels can be of any number or resolution and will primarily be determined by the particular camera utilized in the practice of the invention.

As used herein the term “detecting if the selected body part is in the image” refers to the process of selecting a digital image that may have a selected body part in the image to determine first if it is there, next its position, and lastly if there is a motion that is a desired motion that initials a web application. This can be done on the terminal or on the communication network at the application site, a server, or the like. This is done by first selecting regions that might be indicative of the selected body part and then applying the trained classifier of the selected body part to the selected regions in order to determine if a body part is found and where it is such that repeated detection will lead to a determination of movement or not. In one embodiment of the present invention such detection involves first selecting the probable regions. This can be done based on comparing where the last known position of a body part is/was, by logical selection of where the part might be expected to be or just a random selection of locations. The procedure of selecting probable regions is meant to cut down on the processing time to find the body part. The exact size of selected regions will be based on the accuracy of the determination desired, if the selection is purely random or has some basis to expect the pixels represent the body part (e.g. where the body part was in motion and the program can anticipate where it might now be), or if there is some other logical reason to select one or more pixels to testing. Obviously, the least amount of pixels chosen the faster the program is and one skilled in the art in view of this disclosure can balance accuracy with the likelihood of finding the body part with that pixel to select the number of pixels to be utilized in the method. A boosting classifier and cascade classifier is created for the system and a followed by a HOG image of each pixel that is selected. After that portion each of the HOG images can be subjected to a binary predictor to selected regions of the image and determining which region could be of the selected body part, followed by applying a boosting classifier to the regions which could be the selected body part and applying a sequential cascade of the boost classified regions against a reference body part until the classified regions are accepted or rejected as being from a selected body part.

As used herein the term “position” refers to the location of the selected body part in the digital image being looked at between multiple images it refers to the movement i.e. the change in position between each successive recorded position such that collectively they can become a movement.

As used herein the term “reference pattern” or “reference body part” refers to selected digital pixels from known selected body parts and known selected movements that can be used for comparing the unknown digital picture for determination of the presence of the selected body part and if there is movement and if it is the desired movement which initials a particular designated web application.

As used herein the term “sending information” means the transfer of digital information from one location to another. The information could be from a web camera to a resident memory where a software program processes it or to a web application on the communication network for indicating a particular action or the like.

As used herein the term “boosting classifier” is a term that refers to the combination of two or more weak classifiers to linearly form a more discriminative classifier. One can apply an algorithm, for such procedure, for example, using Adaboost.

As used herein the term “sequential cascade classifier” takes the input of several boosted classifiers in order to determine if a pixel or region is accepted or selected as the body part. The sequential cascade classifier organizes the boost classifier such that a low false alarm rate is achieved for the boost classifier and cascade classifier. See for example “Robust Real-Time Object Detection” by Viola and Jones.

As used herein the term “binary predictor” describes a class of simple classifiers that make judgment based on ranking the value of a given subset of pixels.

As used herein the term Histogram of oriented gradients or “HOG” image are feature descriptors used in computer vision and image processing for the purpose of object detection, notably in this invention for the detection of a human using the system. The technique counts occurrences of gradient orientation in localized portions of the digital image. This method is similar to that of edge orientation histograms, scale-invariant feature transform descriptors, and shape contexts, but differs in that it on a dense grid of uniformly spaced cells and uses overlapping local contrast normalization for improved performance. The essential thought behind the Histogram of Oriented Gradient descriptors is that local object appearance and shape within an image can be described by the distribution of intensity gradients or edge directions, specifically the orientation of the pixel. The implementation of these descriptors can be achieved by dividing the image into small connected regions, called cells, and for each cell compiling a histogram of gradient directions or edge orientations for the pixels within the cell. The combination of these histograms then represents the descriptor. For improved performance, the local histograms can be contrast-normalized by calculating a measure of the intensity across a larger region of the image, called a block, and then using this value to normalize all cells within the block. This normalization results in better invariance to changes in illumination or shadowing.

The Histogram of Oriented Gradients descriptor maintains a few key advantages over other descriptor methods. Since the Histogram of Oriented Gradients descriptor operates on localized cells, the method upholds invariance to geometric and photometric transformations; such changes would only appear in larger spatial regions. Moreover, coarse spatial sampling, fine orientation sampling, and strong local photometric normalization permits the individual body movement. The HOG is thus particularly suited for human detection in digital images.

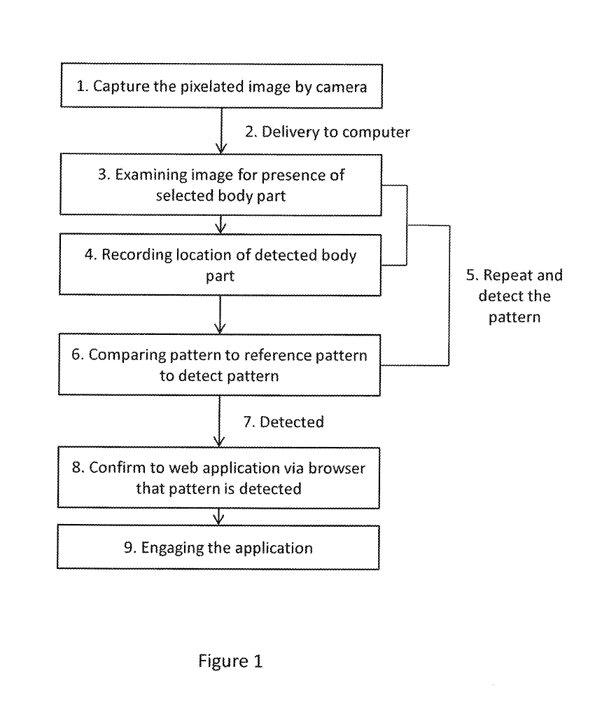

Now referring to the figures, FIG. 1 is a flow chart of the method of the present invention. In the beginning, the user of the present method captures a pixilated image 1 by using a web camera or the like hooked up to a computer 2 which can store the digital image for manipulation. The digital image 1 is examined for the potential presence of a desired body part 3 by repeatedly 5 looking at several pixels in the digital image. Any pixels that are determined to be of the desired body part are noted by their location 4. Thus by the computer (locally or internet based) comparing the pattern of movement of the body part by extrapolation from the movement of the pixels, the pattern can be compared to a reference pattern 6 and if the patterns are the same or similar a positive determination of the desired gesture can be made.

If the pattern is detected 7 then a confirmation can be sent or indicated to a corresponding web application via the browser 8 and thus the appropriate signal will cause the engagement of the web application 9.

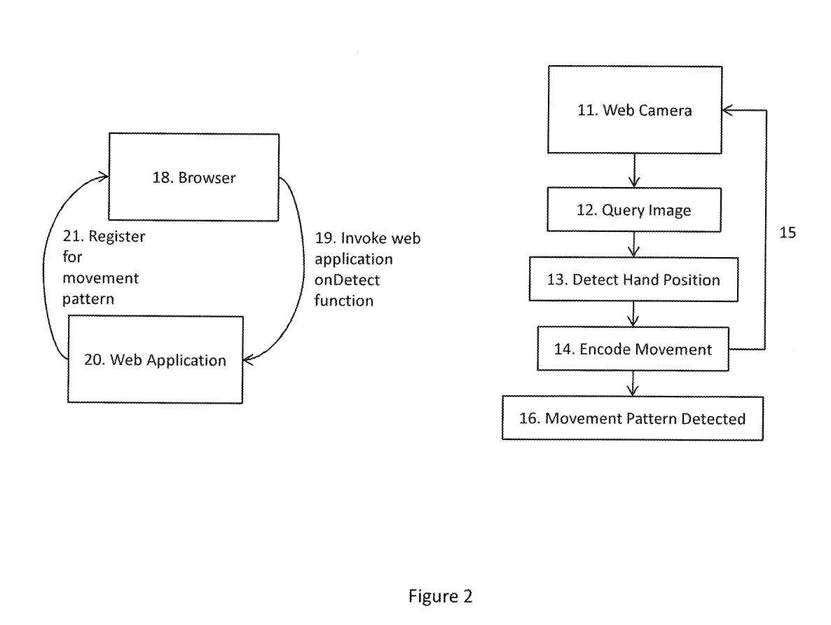

FIG. 2 is a relationship chart of the method for triggering the web application using the present method specific for detection of a hand. In this chart, a web camera 11 takes a digital picture of a user. In this case one that might have a hand that one is determining if a specific hand gesture is being made. Once the digital picture is available, the image is queried 12 for individual pixels and to determine with selected individual pixels if the pixel represents pixels from a hand images. The location of positively detected pixels is then utilized to detect the hand position 13. The location of the hand movement is encoded 14 as a location of the hand and by repeating these first four steps 15 one can then detect a movement pattern 16.

If the pattern is a desired pattern that indicates the initiation of a web application 20 then the local computer performing the movement detection can locate the web application browser 18. The browser 18 can then invoke the initiation 19 of the Web application 20. The Web application is then initialed 21 and through the browser 18 the user will detect the application of the web application.

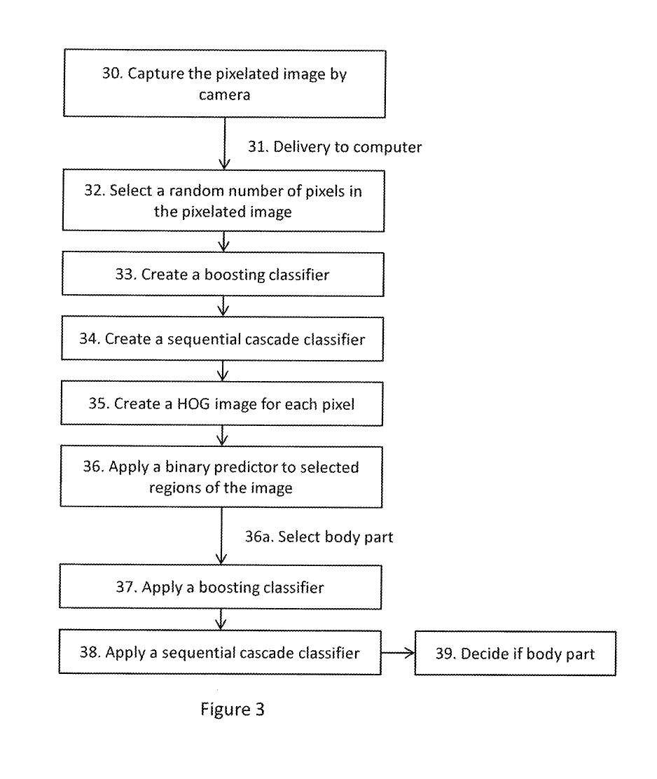

FIG. 3 is a flow chart of an embodiment of the detection of a body part gesture using the present invention. Initially, a web cam will capture a pixilated image 30 of an individual who may or may not be making a desired gesture. The digital image is then delivered to a user's computer 31 where the probable regions are selected in the pixilated image 32 at points that could be the selected body part. The regions are captured because of the need to reduce the amount of data transfer and to lower the false alarm rate.

A boosting classifier 33 and a sequential cascade classifier 34 are both created (usually previous to this step) based on the picture and the expectation of where the body part might be and what the potential movement desired is. Meanwhile there is a HOG image created of each pixel 35. A binary predictor is applied to the pixels to select regions of the of the pixilated image 36 and that is in turn used to determine those which might be the body part, i.e. the select region is the selected body part 36a.

Once that occurs those regions are subjected to the boosting classifier 37 and the sequential cascade 38 to determine if the regions are representative for sure of the body part 39.

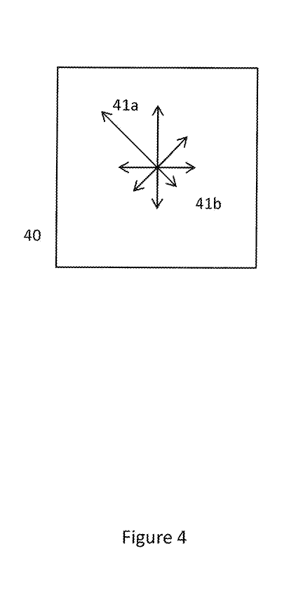

FIG. 4 represents a HOG image of a pixel 40 by orientation and strength. Pixel 40 is represented by an 8-D vector showing strengths and direction of the pixel. Vector 41a shows a vector of one direction with a large strength while 41b shows one of opposite direction with low strength. The remaining vectors all represent a different direction with their own strengths being the same or different.

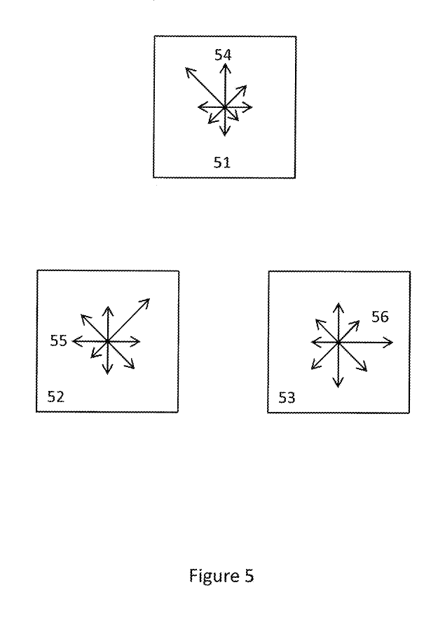

In FIG. 5 a binary predictor is depicted using HOG images generated in earlier steps. The binary predictor returns a 0 or 1 based on comparison of 2 or more pixel strengths in a specific orientation. Shown are pixels X 51, Y₁ 52, Y₂ 53, which each show a variety of strengths and directions of their respective vectors 54, 55 and 56. In this embodiment the Binary (B)=X(3)>Y₁(4) and X(3)>Y₂(1).

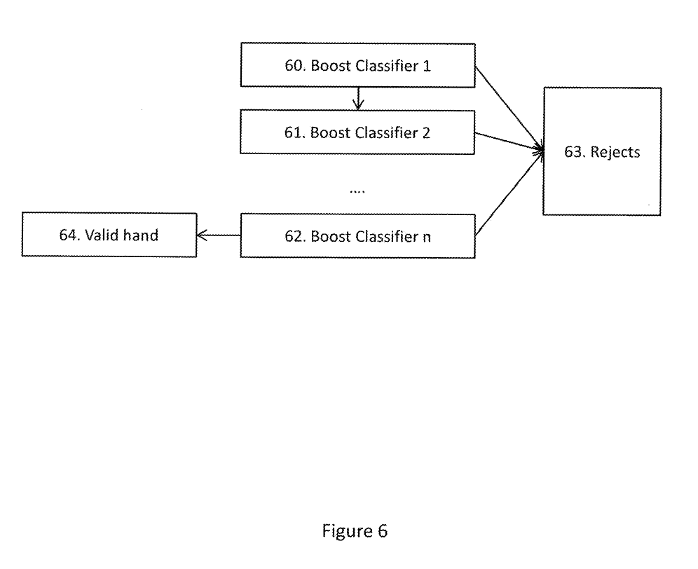

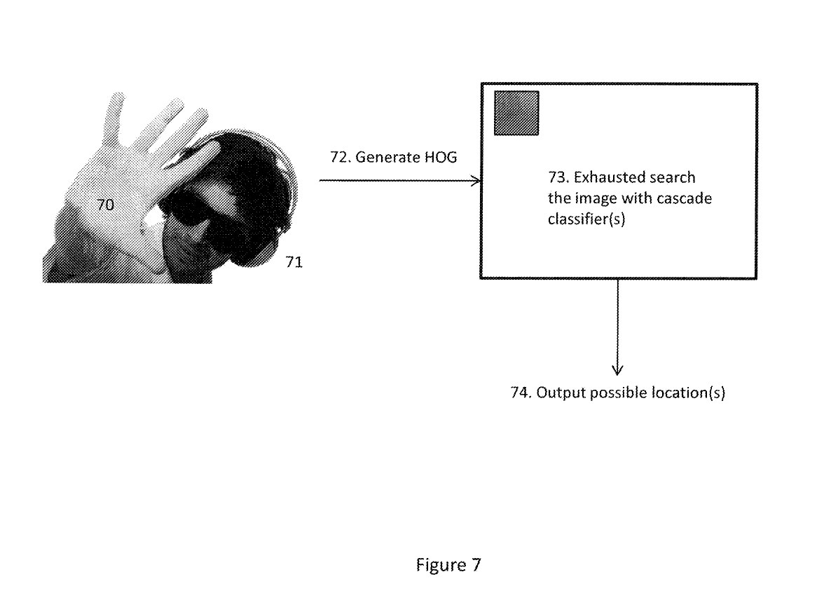

A boost Classifier returns a 0 or 1 based on the composition of Binary predictor outputs, i.e. A=Σ_{WiBi}. FIG. 6 depicts the cascade classifier where if 0, stop and return reject, if 1 proceeding to the next boost classifier until one runs out of boost classifiers or determines one had a valid hand. Shown is boost classifier one 60, Boost classifier two 61, and boost classifier n 62 which are tested and if rejected 63 is determined not a hand but if positive then the boost classifier represents a valid hand 64. Lastly, in FIG. 7 a more general view of the hand detection is depicted. Human user 71 is holding up a hand 70. The HOG is generated 72 from which an exhausted search of the image is performed with cascade classifier(s) 73 until possible locations are output 74.

What is claimed is:

1. A method of communicating a selected user movement pattern of a select body part to invoke a wire communication network application using a camera attached to a wire communication network communication terminal comprising:
a) capturing a pixilated digital image of the user by the camera;
b) delivering the image to the terminal;
c) detecting if the selected body part is in the image and recording its position;
d) repeating steps a) through c) and collecting multiple body part positions and their pattern;
e) comparing the multiple positions pattern to a reference pattern until a selected movement pattern is detected;
f) sending information from the terminal to the wire communication network that the movement pattern is detected; and
g) engaging the wire communication network application based on the body part movement pattern.

2. A method according to claim 1 wherein the body part is detected by the method comprising:
a) creating a HOG image of each pixel;
b) applying a binary predictor to selected regions of the image and determining which region could be of the selected body part;
c) applying a boosting classifier to the regions which could be the selected body part; and
d) applying a sequential cascade of the boost classified regions against a reference body part until the classified regions are accepted or rejected as being from a selected body part.

3. A method according to claim 1 wherein the wire communication network is the internet.

4. In another embodiment it relates to offline training a cascade classifier of a body part gesture by the method comprising:
a) collecting a select number of samples of desired body part identified as positive;
b) collecting samples identified as a negative that cannot be correctly rejected by the classifier;
c) selecting best performance binary predictors in the samples, and composing boosting classifier with the samples until the selected detecting rate/false alarm rate is reached;
d) composing a new cascade classifier with current boosting classifier, repeat steps b) to c) until a global detecting rate/false alarm rate is reached.
